(19) United States
(12) Patent Application Publication
(10) Pub. No.: US 2020/0349190 A1
(43) Pub. Date: Nov. 5, 2020

(54) INTERACTIVE MUSIC ON-DEMAND METHOD, DEVICE AND TERMINAL

(71) Applicant: Baidu Online Network Technology (Beijing) Co., Ltd, Beijing (CN)

(72) Inventors: Jianlong Li, Beijing (CN); Xiangtao Jiang, Beijing (CN); Shiquan Ye, Beijing (CN); Di Peng, Beijing (CN); Xiangjie Yin, Beijing (CN); Wenjuan Zhou, Beijing (CN); Zhendong Ma, Beijing (CN)

(73) Assignee: Baidu Online Network Technology (Beijing) Co., Ltd., Beijing (CN)

(21) Appl. No.: 16/687,287

(22) Filed: Nov. 18, 2019

(30) Foreign Application Priority Data
Apr. 30, 2019 (CN) 201910361907.3

(51) Int. Cl. G06F 16/638; G06F 3/16

(52) U.S. Cl. CPC G06F 16/639; G06F 3/165

(57) ABSTRACT

An interactive music on-demand method, device, and terminal are provided. The method includes: acquiring on-demand requirement information; determining that the on-demand requirement information meets an inquiry requirement condition; and generating an on-demand inquiry voice according to the on-demand requirement information and an on-demand option set corresponding to the on-demand requirement information, in response to the on-demand requirement information meeting the inquiry requirement condition; acquiring on-demand selection information in response to the on-demand inquiry voice; and playing music according to the on-demand selection information.

### CROSS-REFERENCE TO RELATED APPLICATION

This application claims priority to Chinese Patent Application No. 201910361907.3, filed on Apr. 30, 2019, which is hereby incorporated by reference in its entirety.

### TECHNICAL FIELD

The present application relates to the technical field of voice interaction, and in particular, to an interactive music on-demand method, device, and terminal.

### BACKGROUND

At present, users usually put forward a wide scope of demands to smart devices. However, there is not much interaction between smart devices and users, which leads that the recommended items cannot meet the demand of the user. For example, when an instruction of “I want to listen to pop music” is sent to the smart playing device, the song recommended by the smart playing device is inaccurate, and the request of the user cannot be explored deeply, or the song cannot be recommended according to the interest of the user.

### SUMMARY

An interactive music on-demand method, device, and terminal are provided according to embodiments of the present application, to solve at least the above technical problems in the existing technology.

In the first aspect, an interactive music on-demand method is provided according to an embodiment of the present application, the method includes:
acquiring on-demand requirement information;
determining that the on-demand requirement information meets an inquiry requirement condition; and generating an on-demand inquiry voice according to the on-demand requirement information and an on-demand option set corresponding to the on-demand requirement information, in response to the on-demand requirement information meeting the inquiry requirement condition;
acquiring on-demand selection information in response to the on-demand inquiry voice; and;
playing music according to the on-demand selection information.

In one implementation, the determining that the on-demand requirement information meets an inquiry requirement condition, includes:
determining that no on-demand inquiry related to the on-demand requirement information is performed within a historical period.

In one implementation, the determining that the on-demand requirement information meets an inquiry requirement condition, includes:
determining that a satisfaction of a user on the on-demand inquiry voice within a historical period is less than a first threshold.

In one implementation, the determining that the on-demand requirement information meets an inquiry requirement condition, includes:
determining that a satisfaction of a user on a default played music within a historical period is less than a second threshold.

In one implementation, the generating an on-demand inquiry voice according to the on-demand requirement information and an on-demand option set corresponding to the on-demand requirement information, in response to the on-demand requirement information meeting the inquiry requirement condition, includes:
acquiring a plurality of on-demand options in the on-demand option set, and trigger rates of the respective on-demand options;
selecting an on-demand option with a trigger rate greater than or equal to a third threshold, and generating on-demand inquiry information according to the selected on-demand option and the on-demand requirement information; and
generating the on-demand inquiry voice according to the on-demand inquiry information.

In the second aspect, an interactive music on-demand device is provided according to an embodiment of the present application, the device includes:
an on-demand requirement acquisition module, configured to acquire on-demand requirement information;
an on-demand inquiry determination module, configured to determine that the on-demand requirement information meets an inquiry requirement condition;
an on-demand inquiry voice generation module, configured to generate an on-demand inquiry voice according to the on-demand requirement information and an on-demand option set corresponding to the on-demand requirement information, in response to the on-demand requirement information meeting the inquiry requirement condition;
an on-demand selection module, configured to acquire on-demand selection information in response to the on-demand inquiry voice; and
a music playing module, configured to play music according to the on-demand selection information.

In one implementation, the on-demand inquiry determination module includes:
an inquiry record determination unit, configured to determine that no on-demand inquiry related to the on-demand requirement information is performed within a historical period.

In one implementation, the on-demand inquiry determination module includes:
an inquiry satisfaction determination unit, configured to determine that a satisfaction of a user on the on-demand inquiry voice within a historical period is less than a first threshold.

In one implementation, the on-demand inquiry determination module includes:
a music satisfaction determination unit, configured to determine that a satisfaction of a user on a default played music within a historical period is less than a second threshold.

In one implementation, the on-demand inquiry voice generation module includes:
an on-demand option acquisition unit, configured to acquire a plurality of on-demand options in the on-demand option set, and trigger rates of the respective on-demand options;
an on-demand option selection unit, configured to select an on-demand option with a trigger rate greater than or equal to a third threshold, and generate on-demand inquiry information according to the selected on-demand option and the on-demand requirement information;
an inquiry voice generation unit, configured to generate the on-demand inquiry voice according to the on-demand inquiry information.

The functions of the device may be implemented by hardware, or may be implemented by hardware executing corresponding software. The hardware or software includes one or more modules corresponding to the functions described above.

In a possible design, the interactive music on-demand device structurally includes a processor and a memory for storing a program supporting the interactive music on-demand device to execute the above-described interactive music on-demand method in the first aspect, the processor being configured to execute the program stored in the memory. The interactive music on-demand device may further include a communication interface for communicating with other apparatus or communication networks.

In the third aspect, a computer readable storage medium is provided according to an embodiment of the present application, for storing computer software instructions for use by the interactive music on-demand device, to execute the above-described interactive music on-demand method in the first aspect .

One technical solution of the above technical solutions has the following advantages or benefit effects: after acquiring the on-demand requirement information, the on-demand inquiry voice can be generated according to the on-demand requirement information and the corresponding on-demand option set. In the voice interaction with the user, through multi-turn voice dialogue, the scope of search and song recommendation can be gradually narrowed down, and the real demands of users can be deeply explored. It guides users to specify the general requirement. The final recommended music is more in line with the interest of the user.

The above summary is for the purpose of the specification only and is not intended to limit in any way. In addition to the illustrative aspects, implementations, and features described above, further aspects, implementations, and features of the present application will be readily understood by reference to the drawings and the following detailed description.

### BRIEF DESCRIPTION OF THE DRAWINGS

In the drawings, unless otherwise specified, identical reference numerals will be used throughout the drawings to refer to identical or similar parts or elements. The drawings are not necessarily drawn to scale. It should be understood that these drawings depict only some implementations disclosed in accordance with the present application and are not to be considered as limiting the scope of the present application.

FIG. 1 is a schematic flowchart of an interactive music on-demand method according to an embodiment of the present application;

FIG. 2 is a schematic flowchart of another interactive music on-demand method according to an embodiment of the present application;

FIG. 3 is a structural block diagram of an interactive music on-demand device according to an embodiment of the present application;

FIG. 4 is a structural block diagram of another interactive music on-demand device according to an embodiment of the present application; and

FIG. 5 is a schematic diagram of an interactive music on-demand terminal according to an embodiment of the present application.

### DETAILED DESCRIPTION OF THE EMBODIMENTS

In the following, only certain exemplary embodiments are briefly described. As those skilled in the art would realize, the described embodiments may be modified in various different ways, all without departing from the spirit or scope of the present application. Accordingly, the drawings and description are to be regarded as illustrative in nature and not restrictive.

Embodiment 1

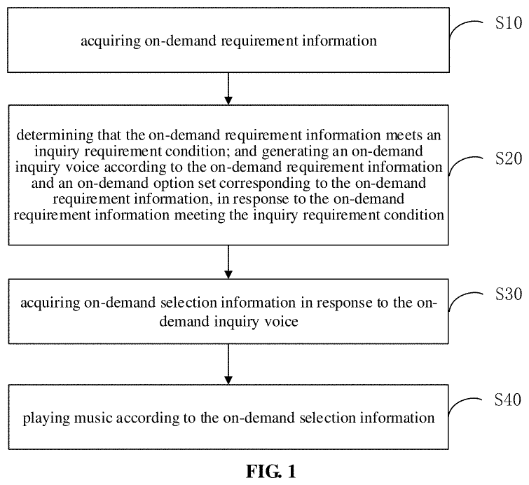

In a specific implementation, as shown in FIG. 1, an interactive music on-demand method is provided, the method includes:
S10: acquiring on-demand requirement information;
S20: determining that the on-demand requirement information meets an inquiry requirement condition; and generating an on-demand inquiry voice according to the on-demand requirement information and an on-demand option set corresponding to the on-demand requirement information, in response to the on-demand requirement information meeting the inquiry requirement condition;
S30: acquiring on-demand selection information in response to the on-demand inquiry voice; and
S40: playing music according to the on-demand selection information.

In one example, the on-demand requirement information may be acquired from the on-demand requirement voice sent by the user, and the on-demand requirement voice may be a general requirement for the user to demand the music. For example, the on-demand requirement voice is “Xiao Du, Xiao Du, please play pop music”, and the on-demand requirement information acquired is “play pop music”. For another example, the on-demand requirement voice is “Xiao Du, Xiao Du, please play French songs”, and the on-demand requirement information acquired is “play French songs”.

After acquiring the on-demand requirement information, it may first determine whether or not the on-demand requirement information belongs to the general on-demand requirement information according to the on-demand requirement information. For example, on-demand requirement information with unclear requirement such as “play pop music”, “play French songs” and the like is the on-demand requirement information with general requirement, while on-demand requirement information with clear requirement such as “playing Jay Chou's Qilixiang” and the like is not the on-demand requirement information with general requirement. For the non-on-demand requirement information with general demand, music can be directly played according to the on-demand requirement information.

For example, the song “Qilixiang” is played directly. For the on-demand requirement information with general demand, it is also necessary to determine whether or not to perform an on-demand inquiry according to the inquiry requirement condition. The inquiry requirement condition may include following examples. A smart playing device does not send the same or the similar on-demand inquiry voice for on-demand requirement information before acquiring the on-demand requirement information; or the user is not satisfied with the on-demand inquiry voice generated by the smart playing device for the on-demand requirement information; or the user is not satisfied with a default played music generated by the smart playing device according to the same or the similar on-demand requirement information, and the like.

If the on-demand requirement information meets any of the above-mentioned inquiry requirement conditions, the smart playing device determines to perform an on-demand inquiry. In an early stage, a correspondence between various on-demand requirement information sent by the user and the on-demand option set may be set. For example, if the on-demand requirement information is the target tag “play pop music”, the on-demand option set corresponding to the target tag “playing pop music” may be set to include a plurality of option tags. The plurality of option tags may include: “Chinese pop music”, “English pop music”, “Indian pop music” and the like. Alternatively, the plurality of option tags may include: “jazz music”, “dance music”, “rock music”, and the like. For another example, if the on-demand requirement information is the target tag “play music in the morning”, the corresponding on-demand option set includes a plurality of option tags, which may include option tag pure music “New Century, a morning sun” and an option tag “Cheerful pure music on the way to school”. For another example, if the on-demand requirement information is the target tag “playing movie-type music”, the corresponding on-demand option set includes a plurality of option tags, and the plurality of option tags may include: “movie theme song” and “movie soundtrack”.

A corresponding on-demand option set is searched for according to the on-demand requirement information, and finally an on-demand inquiry voice is generated. The on-demand inquiry voice may include content related to each option in the on-demand option set. For example, respective options in the on-demand option set include “Chinese pop music,” “English pop music,” and “Indian pop music.” The on-demand inquiry voice may include “Do you want to listen to Chinese pop music, English pop music or Indian pop music?”. Alternatively, respective options in the on-demand option set include “movie theme song”, “movie soundtrack”, then on-demand inquiry voice can include “Do you want to listen to a movie theme song or a soundtrack?”, and the like.

After receiving the on-demand inquiry voice sent by the smart playing device, the user may send an on-demand selection voice corresponding to the on-demand inquiry voice. For example, the on-demand selection voice may include “I want to listen to Chinese pop music”, “I want to listen to jazz music”, “I want to listen to the movie theme song” or the like.

After receiving the on-demand selection voice, the smart playing device parses into the on-demand selection information, and plays the corresponding music according to the on-demand selection information. For example, Chinese pop music includes a plurality of song lists, each song list includes a plurality of songs, and the first three songs can be randomly selected for playing, or select on-demand music that the user prefers to play.

Certainly, the requirement of the user is further explored through multi-turn voice dialog between the user and the smart playing device. For example, after receiving the “I want to listen to Chinese pop music” sent by the user, the smart playing device may also send an on-demand inquiry voice: “Chinese pop music includes a classic pop song list and a latest pop song list. Which song list do you want to listen to?”, and the like. Through the multi-turn voice dialog, the scope of the search and the song recommendation can be gradually narrowed down, to clarify the on-demand requirement of the user.

The smart playing device feeds back the on-demand inquiry voice after acquiring the on-demand requirement voice sent by the user. During the voice interaction with the user, the real requirement of the user is deeply explored, and the user is guided to specify the general requirement. The final recommended music is more in line with the interest of the user. The interactive music on-demand method according to the present implementation can be applied to smart playing devices, for example, smart speakers, smart watches, smart vehicle players, mobile phones, IPADs, and the like.

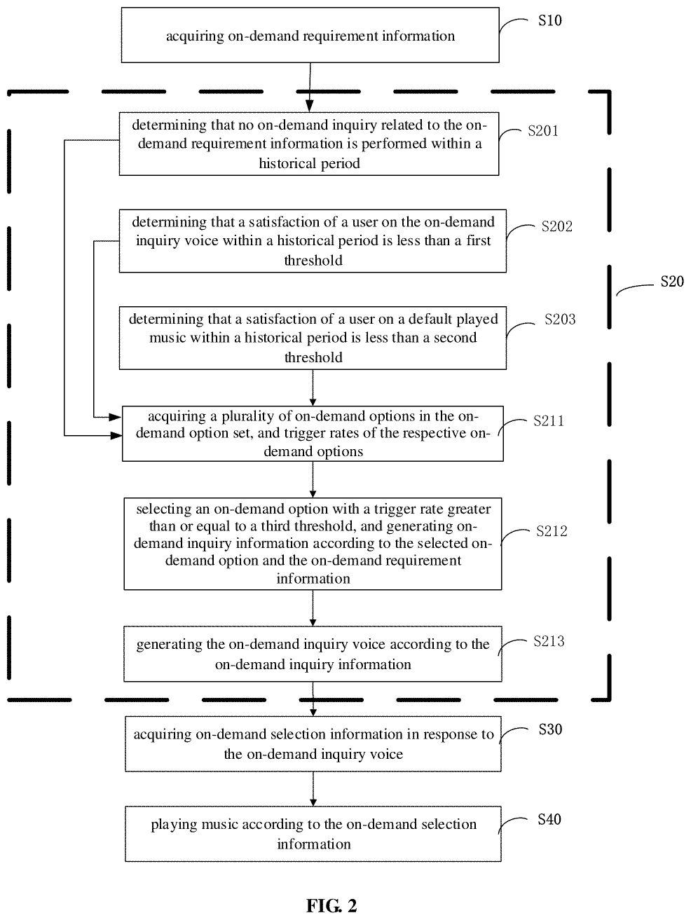

In an implementation, as shown in FIG. 2, S20 includes:
S201: determining that no on-demand inquiry related to the on-demand requirement information is performed within a historical period.

In one example, the historical period refers to any period before acquiring the on-demand requirement information, for example, whether or not there is an on-demand inquiry within the last seven days. Each time an on-demand inquiry voice is generated, it is recorded to facilitate reviewing. If no on-demand inquiry related to the current on-demand requirement information is performed, the smart playing device may not have explored the on-demand requirement information from the on-demand requirement voice sent by the current user, and thus an on-demand inquiry is required.

In an implementation, as shown in FIG. 2, S20 includes:
S202: determining that a satisfaction of a user on the on-demand inquiry voice within a historical period is less than a first threshold.

In an example, an on-demand inquiry related to the current on-demand requirement information is performed within a historical period, but the satisfaction of the user on the historical on-demand inquiry voice is low. If the satisfaction is less than the first threshold, the on-demand inquiry voice is regenerated. Specifically, the on-demand option set included in the last on-demand inquiry voice, for example, “Do you want to listen to Chinese pop music, English pop music or Indian pop music?”, may be changed to another on-demand option set, for example, “Do you want to listen to jazz, dance, or rock music?”. The first threshold can be calculated by a large amount of satisfaction feedback of the user on the on-demand inquiry voice.

In an implementation, as shown in FIG. 2, S20 includes:
S203: determining that a satisfaction of a user on a default played music within a historical period is less than a second threshold.

In one example, no on-demand inquiry related to the current on-demand requirement information is performed within a historical period, instead the default music is played directly, and the feedback of the user on the default music is recorded, and the feedback includes a satisfaction of the user on the default music. If the satisfaction is less than the second threshold, then it indicates that the user's interest needs to be explored, an on-demand inquiry voice is generated. The second threshold may be calculated by the satisfaction feedback of the user on the default music.

In an implementation, as shown in FIG. 2, S20 further includes:
S211: acquiring a plurality of on-demand options in the on-demand option set, and trigger rates of the respective on-demand options;
S212: selecting an on-demand option with a trigger rate greater than or equal to a third threshold, and generating on-demand inquiry information according to the selected on-demand option and the on-demand requirement information; and
S213: generating the on-demand inquiry voice according to the on-demand inquiry information.

In an example, a set of multiple on-demand options corresponding to on-demand requirement information may be manually set, and each on-demand option corresponds to a different trigger rate. When a trigger rate is greater than or equal to 0 and less than 1, the trigger rate is higher, it indicates that the user is more interested in an on-demand option with the trigger rate, and the credibility of the favorite image of the user is higher. The on-demand inquiry information is generated according to the selected on-demand option and the on-demand requirement information, and the on-demand inquiry information covers preferences of the user.

Embodiment 2

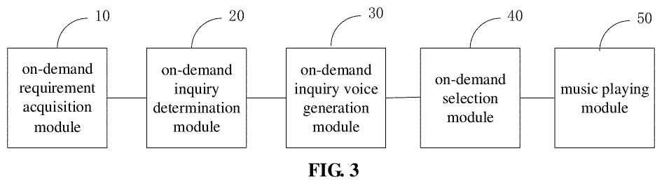

In another specific implementation, as shown in FIG. 3, an interactive music on-demand device is provided, the device includes:
an on-demand requirement acquisition module 10, configured to acquire on-demand requirement information;
an on-demand inquiry determination module 20, configured to determine that the on-demand requirement information meets an inquiry requirement condition;
an on-demand inquiry voice generation module 30, configured to generate an on-demand inquiry voice according to the on-demand requirement information and an on-demand option set corresponding to the on-demand requirement information, in response to the on-demand requirement information meeting the inquiry requirement condition;
an on-demand selection module 40, configured to acquire on-demand selection information in response to the on-demand inquiry voice; and
a music playing module 50, configured to play music according to the on-demand selection information.

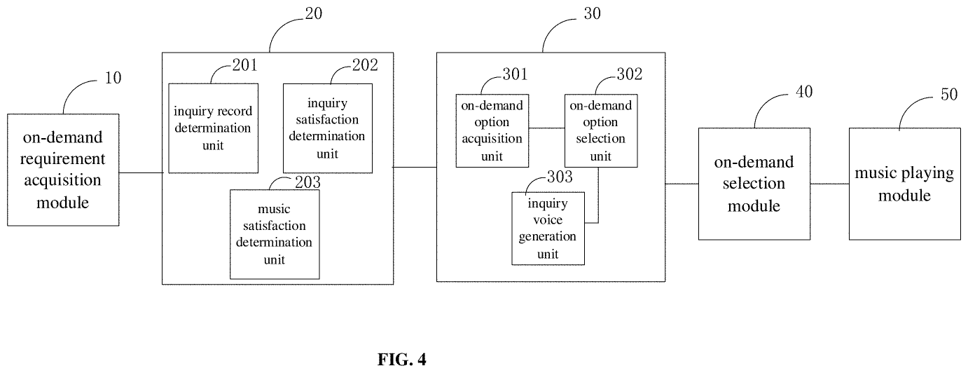

In an implementation, as shown in FIG. 4, the on-demand inquiry determination module 20 includes:
an inquiry record determination unit 201, configured to determine that no on-demand inquiry related to the on-demand requirement information is performed within a historical period.

In an implementation, as shown in FIG. 4, the on-demand inquiry determination module 20 includes:
an inquiry satisfaction determination unit 202, configured to determine that a satisfaction of a user on the on-demand inquiry voice within a historical period is less than a first threshold.

In an implementation, as shown in FIG. 4, the on-demand inquiry determination module 20 includes:
a music satisfaction determination unit 203, configured to determine that a satisfaction of a user on a default played music within a historical period is less than a second threshold.

In an implementation, as shown in FIG. 4, the on-demand inquiry voice generation module 30 includes:
an on-demand option acquisition unit 301, configured to acquire a plurality of on-demand options in the on-demand option set, and trigger rates of the respective on-demand options;
an on-demand option selection unit 302, configured to select an on-demand option with a trigger rate greater than or equal to a third threshold, and generate on-demand inquiry information according to the selected on-demand option and the on-demand requirement information; and;
an inquiry voice generation unit 303, configured to generate an on-demand inquiry voice according to the on-demand inquiry information.

The function of each module in each device in the embodiment of the present application can be referred to the corresponding description in the above-mentioned method, and details are not described herein again.

Embodiment 3

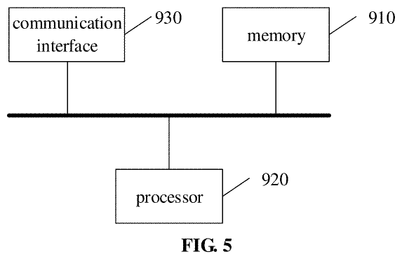

FIG. 5 shows a structural block diagram of an interactive music on-demand terminal according to an embodiment of the present application. As shown in FIG. 5, the terminal includes a memory 910 and a processor 920, wherein a computer program operable on the processor 920 is stored in the memory 910. The processor 920 implements the interactive music on-demand method in above embodiments when the computer program is executed.

The number of the memory 910 and the processor 920 may be one or more.

The terminal also includes:
a communication interface 930 configured to communicate with an external apparatus for data interactive transmission.

The memory 910 may include a high-speed RAM memory and may also include a non-volatile memory, such as at least one magnetic disk memory.

If the memory 910, the processor 920, and the communication interface 930 are implemented independently, the memory 910, the processor 920, and the communication interface 930 may be connected to each other through a bus and communicate with one another. The bus may be an Industry Standard Architecture (ISA) bus, a Peripheral Component Interconnect (PCI) bus, an Extended Industry Standard Architecture (EISA) bus, or the like. The bus may be divided into an address bus, a data bus, a control bus, and the like. For ease of illustration, only one bold line is shown in FIG. 5, but it does not mean that there is only one bus or one type of bus.

Optionally, in a specific implementation, if the memory 910, the processor 920, and the communication interface 930 are integrated on one chip, the memory 910, the processor 920, and the communication interface 930 may implement mutual communication through an internal interface.

In the description of the specification, the description of the terms “one embodiment,” “some embodiments,” “an example,” “a specific example,” or “some examples” and the like means the specific features, structures, materials, or characteristics described in connection with the embodiment or example are included in at least one embodiment or example of the present application. Furthermore, the specific features, structures, materials, or characteristics described may be combined in any suitable manner in any one or more of the embodiments or examples. In addition, different embodiments or examples described in this specification and features of different embodiments or examples may be incorporated and combined by those skilled in the art without mutual contradiction.

In addition, the terms “first” and “second” are used for descriptive purposes only and are not to be construed as indicating or implying relative importance or implicitly indicating the number of indicated technical features. Thus, features defining “first” and “second” may explicitly or implicitly include at least one of the features. In the description of the present application, “a plurality of” means two or more, unless expressly limited otherwise.

Any process or method descriptions described in traffic charts or otherwise herein may be understood as representing modules, segments or portions of code that include one or more executable instructions for implementing the steps of a particular logic function or process. Besides, the scope of the preferred embodiments of the present application includes additional implementations where the functions may not be performed in the order shown or discussed, including according to the functions involved, in substantially simultaneous or in reverse order, which should be understood by those skilled in the art to which the embodiment of the present application belongs.

Logic and/or steps, which are represented in the flowcharts or otherwise described herein, for example, may be thought of as a sequencing listing of executable instructions for implementing logic functions, which may be embodied in any computer-readable medium, for use by or in connection with an instruction execution system, device, or apparatus (such as a computer-based system, a processor-included system, or other system that fetch instructions from an instruction execution system, device, or apparatus and execute the instructions). For the purposes of this specification, a “computer-readable medium” may be any device that may contain, store, communicate, propagate, or transport the program for use by or in connection with the instruction execution system, device, or apparatus. More specific examples (not a non-exhaustive list) of the computer-readable media include the following: electrical connections (electronic devices) having one or more wires, a portable computer disk cartridge (magnetic device), random access memory (RAM), read only memory (ROM), erasable programmable read only memory (EPROM or flash memory), optical fiber devices, and portable read only memory (CDROM). In addition, the computer-readable medium may even be paper or other suitable medium upon which the program may be printed, as it may be read, for example, by optical scanning of the paper or other medium, followed by editing, interpretation or, where appropriate, process otherwise to electronically acquire the program, which is then stored in a computer memory.

It should be understood that various portions of the present application may be implemented by hardware, software, firmware, or a combination thereof. In the above embodiments, multiple steps or methods may be implemented in software or firmware stored in memory and executed by a suitable instruction execution system. For example, if implemented in hardware, as in another embodiment, they may be implemented using any one or a combination of the following techniques well known in the art: discrete logic circuits having a logic gate circuit for implementing logic functions on data signals, application specific integrated circuits with suitable combinational logic gate circuits, programmable gate arrays (PGA), field programmable gate arrays (FPGAs), and the like.

Those skilled in the art may understand that all or some of the steps carried in the methods in the foregoing embodiments may be implemented by a program instructing relevant hardware. The program may be stored in a computer-readable storage medium, and when executed, one of the steps of the method embodiment or a combination thereof is included.

In addition, each of the functional units in the embodiments of the present application may be integrated in one processing module, or each of the units may exist alone physically, or two or more units may be integrated in one module. The above-mentioned integrated module may be implemented in the form of hardware or in the form of software functional module. When the integrated module is implemented in the form of a software functional module and is sold or used as an independent product, the integrated module may also be stored in a computer-readable storage medium. The storage medium may be a read only memory, a magnetic disk, an optical disk, or the like.

The foregoing descriptions are merely specific embodiments of the present application, but not intended to limit the protection scope of the present application. Those skilled in the art may easily conceive of various changes or modifications within the technical scope disclosed herein, all these should be covered within the protection scope of the present application. Therefore, the protection scope of the present application should be subject to the protection scope of the claims.

What is claimed is:

1. An interactive music on-demand method, comprising:
acquiring on-demand requirement information;
determining that the on-demand requirement information meets an inquiry requirement condition; and generating an on-demand inquiry voice according to the on-demand requirement information and an on-demand option set corresponding to the on-demand requirement information, in response to the on-demand requirement information meeting the inquiry requirement condition;
acquiring on-demand selection information in response to the on-demand inquiry voice; and
playing music according to the on-demand selection information.

2. The interactive music on-demand method according to claim 1, wherein the determining that the on-demand requirement information meets an inquiry requirement condition, comprises:
determining that no on-demand inquiry related to the on-demand requirement information is performed within a historical period.

3. The interactive music on-demand method according to claim 1, wherein the determining that the on-demand requirement information meets an inquiry requirement condition, comprises:
determining that a satisfaction of a user on the on-demand inquiry voice within a historical period is less than a first threshold.

4. The interactive music on-demand method according to claim 1, wherein the determining that the on-demand requirement information meets an inquiry requirement condition, comprises:
determining that a satisfaction of a user on a default played music within a historical period is less than a second threshold.

5. The interactive music on-demand method according to claim 1, wherein the generating an on-demand inquiry voice according to the on-demand requirement information and an on-demand option set corresponding to the on-demand requirement information, in response to the on-demand requirement information meeting the inquiry requirement condition, comprises:
acquiring a plurality of on-demand options in the on-demand option set, and trigger rates of the respective on-demand options;
selecting an on-demand option with a trigger rate greater than or equal to a third threshold, and generating on-demand inquiry information according to the selected on-demand option and the on-demand requirement information; and
generating the on-demand inquiry voice according to the on-demand inquiry information.

6. An interactive music on-demand device, comprising:
one or more processors; and
a storage device configured to store one or more programs, wherein
the one or more programs, when executed by the one or more processors, cause the one or more processors to:
acquire on-demand requirement information;
determine that the on-demand requirement information meets an inquiry requirement condition;
and generate an on-demand inquiry voice according to the on-demand requirement information and an on-demand option set corresponding to the on-demand requirement information, in response to the on-demand requirement information meeting the inquiry requirement condition;
acquire on-demand selection information in response to the on-demand inquiry voice; and
play music according to the on-demand selection information.

7. The interactive music on-demand device according to claim 6, wherein the one or more programs, when executed by the one or more processors, cause the one or more processors further to:
determine that no on-demand inquiry related to the on-demand requirement information is performed within a historical period.

8. The interactive music on-demand device according to claim 6, wherein the one or more programs, when executed by the one or more processors, cause the one or more processors further to:
determine that a satisfaction of a user on the on-demand inquiry voice within a historical period is less than a first threshold.

9. The interactive music on-demand device according to claim 6, wherein the one or more programs, when executed by the one or more processors, cause the one or more processors further to:
determine that a satisfaction of a user on a default played music within a historical period is less than a second threshold.

10. The interactive music on-demand device according to claim 6, wherein the one or more programs, when executed by the one or more processors, cause the one or more processors further to:
acquire a plurality of on-demand options in the on-demand option set, and trigger rates of the respective on-demand options;
select an on-demand option with a trigger rate greater than or equal to a third threshold, and generate on-demand inquiry information according to the selected on-demand option and the on-demand requirement information; and
generate the on-demand inquiry voice according to the on-demand inquiry information.

11. A non-transitory computer-readable storage medium comprising computer executable instructions stored thereon, wherein the executable instructions, when executed by a processor, causes the processor to implement the interactive music on-demand method of claim 1.
